(19) United States
(12) Patent Application Publication
(10) Pub. No.: US 2023/0217264 A1
(43) Pub. Date: Jul. 6, 2023

(54) DYNAMIC SPECTRUM SHARING BASED ON MACHINE LEARNING

(71) Applicant: Telefonaktiebolaget LM Ericsson (publ), Stockholm (SE)

(72) Inventors: Ursula CHALLITA, Solna (SE); David SANDBERG, Sundbyberg (SE); Tor KVERNVIK, Täby (SE)

(21) Appl. No.: 17/928,060

(22) PCT Filed: Jun. 5, 2020
(86) PCT No.: PCT/SE2020/050571

§ 371 Date: Nov. 28, 2022

(51) Int. Cl. H04W 16/22; H04W 16/10

(52) U.S. Cl. CPC H04W 16/22; H04W 16/10

(57) ABSTRACT

A method for dynamically assigning communication resources between two or more radio access technologies (RAT) in a wireless access network. The method includes obtaining a network observation oₜ indicating a current state of the wireless access network, predicting a sequence of future states of the wireless access network by iteratively simulating hypothetical communication resource assignments a¹, a², a³ over a time window w starting from the current state, evaluating a reward function for each hypothetical communication resource assignment a¹, a², a³ over the time window w, and dynamically assigning the communication resources based on the simulated hypothetical communication resource assignment a¹ associated with maximized reward function over the time window w when the wireless access network is in the current state.

### TECHNICAL FIELD

The present disclosure relates to wireless access networks arranged to simultaneously support two or more radio access technologies (RATs) in a common frequency band, such as the fourth generation (4G) long term evolution (LTE) and the fifth generation (5G) new radio (NR) RATs defined by the third-generation partnership program (3GPP). There are disclosed methods for dynamically assigning communications resources between two or more RATs in a wireless access network.

### BACKGROUND

Wireless access networks are networks of access points, or transmission points (TRP), to which wireless devices may connect via radio link. A wireless access network normally operates within an assigned frequency band, such as a licensed or an unlicensed frequency band. Both time and frequency resources available for communication in the wireless access network are therefore limited.

A wireless access network may be configured to simultaneously support more than one RAT. The limited communication resources available in the network must then be divided between the two or more RATs. This operation is commonly known as spectrum sharing. Spectrum sharing can be either fixed or dynamic.

In fixed spectrum sharing, the communications resources are fixedly distributed between the two or more RATs in time and/or in frequency according to a permanent or at least semi-permanent configuration made, e.g., by an operator of the wireless access network.

In dynamic spectrum sharing, two or more RATs may use the same communications resources, although not at the same time and geographical area. An arbitrator function distributes the communication resources dynamically over time and frequency between the two or more RATs depending, e.g., on current network state. New decisions on resource allocations may, e.g., be taken on a millisecond basis.

Some known implementations of dynamic spectrum sharing are associated with drawbacks. For instance, known arbitrator functions may not be able to handle fast changes in network state in a robust manner and some delay sensitive user traffic is not always handled optimally.

There is a need for improved methods method of dynamically assigning communication resources between two or more RATs in a wireless access network.

### SUMMARY

It is an object of the present disclosure to provide methods for dynamically assigning communication resources in a wireless access network which alleviates at least some of the drawbacks associated with known systems.

This object is at least partly obtained by a computer implemented method for dynamically assigning communication resources between two or more RATs in a wireless access network. The method comprises obtaining a network observation indicating a current state of the wireless access network, predicting a sequence of future states of the wireless access network by simulating hypothetical communication resource assignments over a time window starting from the current state, and evaluating a reward function for each hypothetical communication resource assignment over the time window. The method also comprises dynamically assigning the communication resources based on the simulated hypothetical communication resource assignment associated with maximized reward function over the time window when the wireless access network is in the current state.

This method accounts for future effects which are likely to occur if a given resource assignment is made when the wireless access network is in the current state. Thus, the current resource assignment accounts for future states of the wireless access network and therefore provides a more proactive bandwidth (BW) split between the two RATs. This can be shown to lead to both improved overall network spectral efficiency and also to improvements in the quality of service for delay sensitive traffic.

According to aspects, the two or more RATs comprise a 3GPP 4G and a 3GPP 5G system. Thus, the methods disclosed herein are applicable during the global roll-out of 5G, i.e., during the transition from 4G to 5G.

According to aspects, the network observation comprises, for each user of the wireless access network, any of; predicted number of bits per physical resource block, PRB, and transmission time interval, TTI, pre-determined requirements on pilot signals, NR support, buffer state, traffic type, recurrently scheduled broadcasting communication resources, and predicted packet arrival characteristics. Notably, the network observation need not be complete in the sense that the observation gives a complete picture of the current network state. Rather, the method is able to operate also based on incomplete network state information, i.e., observations where not all data is available. Also, the network observation may be updated more or less, and some parts of the observation may become outdated from time to time. However, the methods disclosed herein are robust and able to efficiently adapt to make use of the available information in the network observation

According to aspects, the method comprises defining an action space comprising a pre-determined maximum number of allowable communication resource assignments. By limiting the number of allowable actions, the processing is simplified, since the number of possible different actions sequences to potentially consider is reduced. This way a mechanism to limit computational complexity is provided.

According to aspects, the predicting comprises performing a Monte-Carlo Tree Search (MCTS) over the action space and over the time window. The MCTS search is efficient and robust in the sense that promising action sequences are identified and considered by the algorithm in a computationally efficient manner.

According to aspects, the predicting is based on a model trained using a training method based on reinforcement learning (RL). In real world scenarios it is challenging to deploy model-free methods because current state-of-the-art algorithms may require millions of samples before any near-optimal policy is learned. Model-based reinforcement learning scenarios focus on learning a predictive model of the real environment that is used to guide the controller of an agent. This approach is normally more data efficient compared to other learning methods.

According to aspects, the reward function corresponds to a weight metric used by respective communications resource scheduling functions of the two or more RATs. The scheduler weight metric is configured by the operator to reflect a desired network state and differential treatment of different users according to, e.g., requirements on quality of service. Thus, advantageously, the reasoning behind what constitutes a desired state in the network is re-used by the current method.

According to aspects, the method also comprises obtaining a representation function, a prediction function, and a dynamics function. The representation function is configured to encode the network observation into an initial hidden network state, the prediction function is configured to generate a policy vector and a value function for a hidden network state, wherein the policy vector indicates a preferred communication resource assignment given a hidden network state and the value function indicates a perceived value associated with the hidden network state. The dynamics function is configured to generate a next hidden network state in a sequence of hidden network states based on a previous hidden network state and on a hypothetical communication resource assignment at the previous hidden network state comprised in an action space. According to these aspects the method further comprises encoding the network observation into an initial hidden network state by the representation function and predicting the sequence of future states as a sequence of hidden network states starting from the initial hidden network state by, iteratively, generating a policy vector and a value function for a current hidden network state in the sequence of hidden network states by the prediction function, selecting a hypothetical communication resource assignment at the current hidden network state in the sequence based on any of the policy vector, the value functions for child states of the current hidden network state and the number of times these child states have been visited during previous iterations, and updating the next hidden network state in the sequence by the dynamics function applied to the current hidden network state in the sequence and on the selected hypothetical communication resource assignment. The communication resources are then dynamically assigned based on the preferred communication resource assignment for the initial hidden network state in the predicted sequence of future states.

Thus, by the representation function, the prediction function, and the dynamics function, the communications resource assignment is performed taking also likely future consequences in the wireless access network of a given current resource assignment into account. The separation of the processing based on the three functions simplify overview of the method and allow for more convenient analysis of the results.

According to aspects, the method comprises predicting a variable length sequence of future states of the wireless access network. This provides an additional degree of freedom for the communications resource assignment. For instance, if two or more options for assignment appear relatively similar in terms of potential future rewards, then the method may look further into the future compared to if the best choice of communications resource assignment appears straight forward already by looking only a few or even one time step into the future. Also, depending on the available network observation data, the method may need to adjust the number of future states considered to reach the desired performance.

According to aspects, the method comprises predicting a pre-configurable fixed length sequence of future states of the wireless access network. A fixed length sequence of future states offers a low complexity implementation which is also robust and potentially also with more predictable performance.

The object is also at least in part obtained by a computer implemented method, performed by a network node, for dynamically assigning communication resources between two or more RATs in a wireless access network. The method comprises obtaining a representation function and a network observation indicating a current state of the wireless access network, encoding the network observation into an initial hidden network state by the representation function, obtaining a prediction function, wherein the prediction function is configured to generate a policy vector for a hidden network state, wherein a policy vector indicates a preferred communication resource assignment given a hidden network state, and dynamically assigning the communication resources based on the output of the prediction function applied to the initial hidden network state. Thus, at least some of the advantages discussed above can be obtained with a relatively simple method offering low computational complexity, which is an advantage.

The object is also at least in part obtained by a computer implemented method, performed by a network node, for dynamically assigning communication resources between two or more RATs in a wireless access network. The method comprises initializing a representation function, a prediction function, and a dynamics function. The representation function is configured to encode a network observation into an initial hidden network state, the prediction function is configured to generate a policy vector and a value function for a hidden network state, wherein the policy vector indicates a preferred communication resource assignment given a hidden network state and the value function indicates a perceived value associated with the hidden network state. The dynamics function is configured to generate a next hidden network state in a sequence of hidden network states based on a previous hidden network state and on a hypothetical communication resource assignment at the previous hidden network state comprised in an action space. The method also comprises obtaining a simulation model of the wireless access network, wherein the simulation model is configured to determine consecutive network states resulting from of a sequence of communication resource assignments starting from an initial network state. The method further comprises training the representation function, the prediction function, and the dynamics function based on the determined consecutive network states starting from a plurality of randomized initial network states and on randomized sequences of communication resource assignments, and dynamically assigning the communication resources between the two or more RATs in the wireless access network based on the representation function, the prediction function, and the dynamics function. This way an efficient method for training the representation function, the prediction function, and the dynamics function is provided.

According to aspects, the randomized sequences of communication resource assignments are selected during training based on a MCTS operation. The MCTS search is both efficient and accurate, which is an advantage.

According to aspects, the method further comprises training the representation function, the prediction function, and/or the dynamics function based on observations of the wireless access network during the dynamic assignment of the communication resources. This way the functions and the overall method is continuously refined as the wireless access network is operated, which is an advantage. The different functions will also adapt to changes in network behaviour over time, which is a further advantage.

According to aspects, the method comprising training the representation function, the prediction function, and the dynamics function based on randomized sequences of communication resource assignments, wherein the sequences of communication resource assignments are of variable length. This provides a further degree of freedom to the training, which is an advantage.

According to aspects, the method comprising training the representation function, the prediction function, and the dynamics function based on randomized sequences of communication resource assignments, wherein the sequences of communication resource assignments are of a pre-configurable fixed length. This way a robust training method is obtained which is also easy to set up.

There are also disclosed herein network nodes, computer programs, and computer program products associated with the above-mentioned advantages.

### BRIEF DESCRIPTION OF THE DRAWINGS

The present disclosure will now be described in more detail with reference to the appended drawings, where:

FIG. 1 shows an example wireless access network supporting two RATs;

FIG. 2 schematically illustrates an example network architecture with two RATs;

FIG. 3 shows an example communication resource assignment;

FIGS. 4A-F shows an example time sequence of dynamic communication resource assignments;

FIG. 5 illustrates a resource assignment based on predicted future network states;

FIG. 6 schematically illustrates a communication resource assignment method;

FIG. 7 illustrates an iterative algorithm executed on a tree structure;

FIG. 8 shows a flowchart illustrating methods;

FIG. 9 schematically illustrates processing circuitry;

FIG. 10 shows a computer program product;

FIG. 11-12 show flowcharts illustrating methods;

FIGS. 13-14 schematically illustrate processing circuitry; and

FIGS. 15-16 are graphs illustrating example results of the methods proposed herein.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

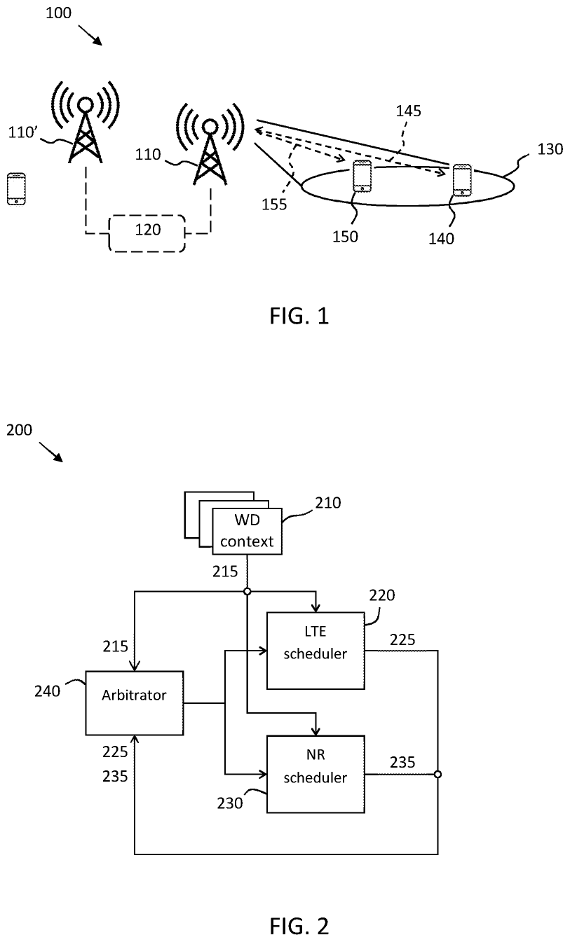

FIG. 1 illustrates a wireless access network 100 where access points 110, 110′ provide wireless network access to wireless devices 140, 150 over a coverage area 130. The access points in a 4G network are normally referred to as an evolved node B (eNodeB), while the access points in a 5G network are often referred to as a next generation node B (gNodeB). The access points 110, 110′ are connected via some type of core network 120, such as an evolved packet core network (EPC).

The wireless access network 100 supports at least two RATs 145, 155 for communicating with wireless devices 140, 150. It is appreciated that the present disclosure is not limited to any particular type of wireless access network type or standard, nor any particular RAT. The techniques disclosed herein are, however, particularly suitable for use with 3GPP defined wireless access networks that support dynamic spectrum sharing. One example or particular importance is dynamic spectrum sharing between an LTE system, i.e., 4G, and an NR system, i.e., 5G.

FIG. 2 schematically illustrates a network architecture 200 comprising two RATs. Wireless devices (WD) in the network are associated with respective contexts 210. A context may comprise information related to, e.g., buffer states, requirements on quality of service (QoS), various capabilities such as multi-antenna operation, and other preferences regarding assigned communications resources. The context may also comprise predicted spectral efficiencies for the wireless device, i.e., estimates of how many bits that can be transmitted in a given time/frequency resource. This information is fed to an LTE scheduler 220 and/or an NR scheduler 230, depending on the type of wireless device. Some wireless devices only support a single RAT, while other wireless devices may of course support more than one RAT. Each scheduler runs a scheduling algorithm which tries to serve each wireless device according to the respective context and available communications resources. Data packets queue up in buffers associated with the wireless devices, and the scheduler decides which buffer to transmit packets from using the limited communications resources in the wireless access network. If enough communication resources are not available to serve all wireless devices according to their respective requirements, then prioritization is performed by the scheduler 220, 230. As a consequence, some packets will remain in the respective buffer and not be transmitted immediately.

Many scheduling functions maintain a weight associated with each wireless device. The weight indicates an urgency in assigning communications resources to the wireless device. A wireless device associated with high QoS wanting to transmit or to receive delay sensitive traffic will be associated with a high weight in case the data of the wireless device is left too long in the buffers, while a wireless device wanting to transmit or to receive non-delay sensitive data will not be associated with as large weight in case its data is left for some time in the buffers of the wireless access network 100.

Scheduling functions in general, and scheduling functions for LTE and NR RATs in particular, are known and will therefore not be discussed in more detail herein.

When dynamic spectrum sharing is implemented in the wireless access network 100, an arbitrator 240 divides the available communications resources between the two schedulers 220, 230. This resource split is determined based on information 215 related to the context 210 and also based on feedback 225, 235 from the two schedulers.

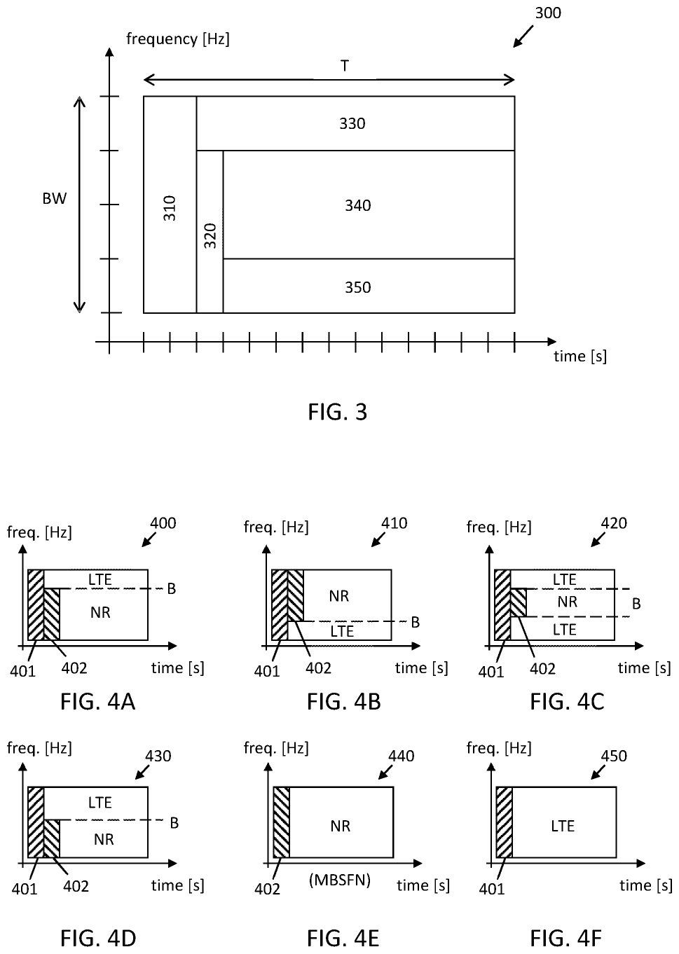

FIG. 3 shows an example of a communications resource assignment 300. The available time/frequency resources are delimited in time by a frame duration T, and in frequency by a frequency band BW. In this example an LTE system has been assigned resources for control channels such as the LTE physical downlink control channel (PDCCH) in a first portion 310 of the frame, while an NR system has been assigned control channel resources, such as an NR PDCCH, in a second part 320. The LTE system is assigned resources for user traffic in a third part 330, while NR is assigned resources in a fourth part 340 for user traffic. A fifth part 350 is unassigned.

FIGS. 4A-4F show other example resource assignments 410-450. The control channel for LTE 401 is normally fixed to the first symbols in the frame unless the frame is a dedicated multimedia broadcast multicast service single frequency network (MBSFN) frame where no LTE control channel is transmitted. The position in the time-frequency grid of the control channel resources for NR 402 in the BW may be a function of a predicted channel quality and other requirements, as shown in the resource assignments 400, 410, and 420. The relative percentage of assigned resources may also vary, as illustrated in FIG. 4D, where the example resource assignment 430 has a smaller percentage of assigned resources to NR compared to, e.g., the resource assignment 400. FIGS. 4E and 4F also show that all resources may be assigned to one RAT in some frames. It is noted that the resource assignment 440 is an LTE MBSFN frame, where no LTE control channels are required.

It is appreciated that the techniques disclosed herein can be applied to arbitration on an uplink (UL) as well as on a downlink (DL).

The whitepaper “Sharing for the best performance—stay ahead of the game with Ericsson spectrum sharing”, 1/0341-FGB 101 843, Ericsson AB, 2019, discusses the general concept of dynamic spectrum sharing. Dynamic spectrum sharing as a concept is generally known and will therefore not be discussed in more detail herein.

The present disclosure focuses on methods for improving dynamic spectrum sharing. Whereas the previously known methods for dynamic spectrum sharing were based on historical network data, the methods disclosed herein try to predict future effects in the wireless access network by simulating the effects in the network from a sequence of potential spectrum sharing decisions forward in time. A model of the network is maintained from which the results of different communication resource assignments in terms of, e.g., scheduler states, can be estimated. Thus, a given sequence of resource assignments over time can be evaluated by the model before it is actually applied in the real network.

This way predicted future consequences of a number of potential candidate communications resource assignments can be compared, and the resource assignment associated with the best overall network behavior over a future time window can be selected. An arbitrator function, such as the arbitrator function 240 in FIG. 2, may account for future states of the network when deciding on the resource assignment between the two or more RATs, which enables a more efficient resource split between two RATs, such as between LTE and NR. The proposed methods improve overall spectral efficiency of the wireless access network, and also improve user quality of service for delay sensitive traffic.

By predicting the future effects in a wireless access network of a given resource assignment, it becomes possible to more accurately account for QoS requirements (like latency or throughput) of one or more underlying applications executed by the wireless devices in the wireless access network. It also becomes possible to provide a more even or smoother traffic allocation over a longer time window, in order to, e.g., meet requested quality of service levels over time. An arbitrator based on the techniques disclosed herein will also be able to improve on long term fairness and QoS as opposed to instantaneous reward and fairness.

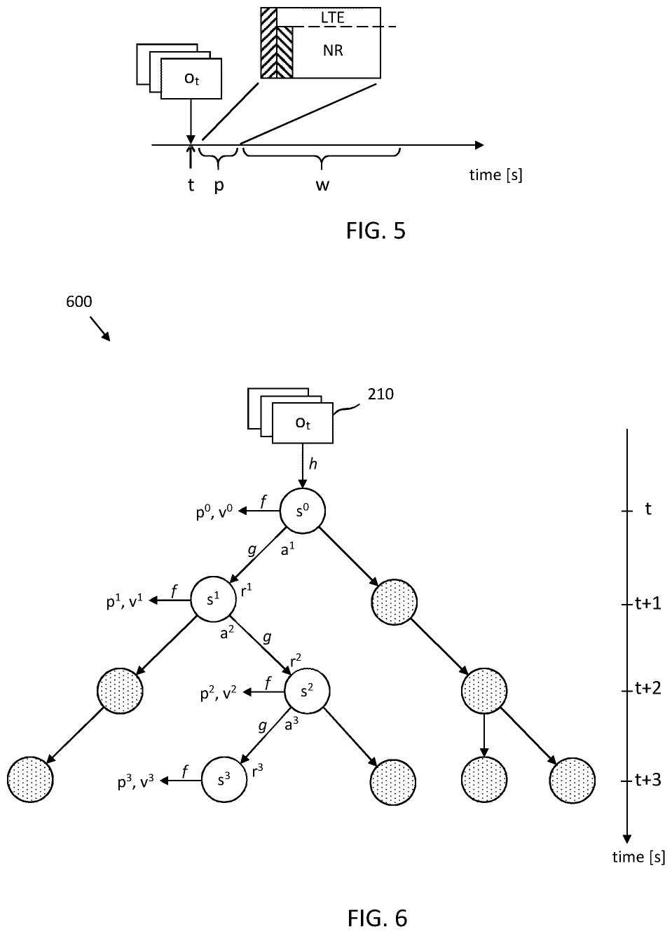

With reference to FIG. 5, the herein proposed methods first obtain information related to current network state at time t. This is referred to as an observation of network state oₜ. The observation is used to predict consequences of different sequences of resource assignments over a future time window w. A resource assignment which is likely to result in a desired future network behavior, such as maximizing some notion of reward over the time window w is then selected for the next frame p. One such notion of reward may, e.g., be the avoidance of transmission buffer overflow.

Some aspects of the methods are based on a reinforcement learning (RL) technique for dynamic spectrum sharing. RL is an area of machine learning concerned with how a software agent should act in an environment in order to maximize some notion of cumulative reward. Reinforcement learning is one of three basic machine learning paradigms, alongside supervised learning, and unsupervised learning.

The environment, i.e., the wireless access network 100, is modelled as a Markov decision process (MDP). Notably, any scheduling functions implemented in the wireless access network 100 are inherently also part of the environment. This means that a trained model will account for the characteristics of the different schedulers that are active in the wireless access network 100. At a point in time, the network is assumed to be in one network state in a finite or infinite set of possible states. The network transitions between states over time as a consequence of different communications resource assignments. One network parameter which may be taken as part of the network state is the status of the different transmission buffers or queues in the network. A resource assignment is an action comprised in an action space. The core problem of MDPs is to find a “policy” for the agent: a function that specifies the action that the agent will choose when in some given state. Once a Markov decision process is combined with a policy in this way, this determines the action, i.e., resource assignment, for each network state and the resulting combination behaves like a Markov chain. The goal is to choose the policy that will maximize some cumulative function of the random rewards, typically an expected discounted sum over a potentially infinite horizon. The present disclosure may, as noted above, use scheduler weights from the two or more RATs as the reward function.

Monte Carlo Tree Search (MCTS), most famously used in game-play artificial intelligence (e.g., the game of Go), is a well-known strategy for constructing approximate solutions to sequential decision problems. Its primary innovation is the use of a heuristic, known as a default policy, to obtain Monte Carlo estimates of downstream values for states in a decision tree. This information is used to iteratively expand a decision tree towards regions of states and actions that an optimal policy might visit.

MCTS iteratively explores the action space, gradually biasing the exploration toward the most promising regions of the search tree. Each search consists of a series of simulated games of self-play that traverse a tree from root state until a leaf state is reached. Each iteration, normally referred to as a tree-walk, involves four phases:
1—Selection: The method starts at the root node, then moves down the tree by selecting optimal child nodes until a leaf node (no known children so far) is reached.
2—Expansion: If the leaf node is a not a terminal node (it does not terminate the game) then one or more child nodes are created according to available actions at the current state (node), one of these child nodes are selected for expansion.
3—Simulation: Run a simulated rollout from the selected child node until a terminal state is found. The terminal state contains a result (value) that will be returned upwards in the backpropagation phase. Note that the states or nodes in which the rollout passes through are not considered visited.
4—Backpropagation: After the simulation phase, a result is returned. All nodes from the selected child node up to the root node will be updated by adding the result to their value and increase the count of visits at each node.

In the present disclosure, each node corresponds to a network state. A terminal state is defined as reached when a time instant sufficiently distant from the current time instant (corresponding to the network state at the root node) has been reached. This ‘sufficiently distant state’ may be defined as a fixed number of states away from the current state, or a defined as a variable distance away from the current state.

“Mastering Atari, Go, Chess and Shogi by Planning with a Learned Model”, by Julian Schrittwieser, Ioannis Antonoglou, Thomas Hubert, Karen Simonyan, Laurent Sifre, Simon Schmitt, Arthur Guez, Edward Lockhart, Demis Hassabis, Thore Graepel, Timothy Lillicrap, and David Silver, arXiv:1911.08265v2, 21 Feb. 2020, discusses a similar example of this RL technique, although in a different context. The methods and techniques discussed in this paper are applicable also in the presently discussed context of dynamic spectrum sharing.

As an example of the herein proposed techniques, consider a single cell frequency division duplex (FDD) co-located downlink (DL) scenario for NR and LTE spectrum sharing. Consider a 15 kHz NR numerology and that both LTE and NR configured frequency bandwidths (BW) are the same. LTE and NR subframes are assumed to be aligned in time. The following assumptions are considered as well:
LTE physical downlink control channel (PDCCH) is restricted to symbols #0 and #1 (if NR PDCCH is present)
NR has no signals/channels in symbols #0 and #1 (four port LTE cell reference signal (CRS) is assumed)
NR PDCCH is limited to symbol #2, assuming that the wireless device only supports type-A scheduling (no mini-slots).
In LTE subframes where no NR PDCCH is transmitted in the overlapped NR slots LTE PDCCH could span 3 symbols.

The action space for the RL method is defined by a limited number of BW splits between LTE and NR for DL transmission for subframe p (see FIG. 5). The total number of possible actions is then n^{s}, where s is the length of the future time window w (in frames) and n is the total number of allowed BW splits in the action space at a particular time.

A network observation may, for example, be defined by one or more of the following information quantities:
Predicted number of bits per physical resource block (PRB) and transmission time interval (TTI) for each wireless device. This number depends on the current channel quality of the propagation channel between a wireless device and an access point.
A matrix with Nᵤₛₑᵣ×N_{prb}×Nₜₜᵢ elements, where each element contains the estimated number of bits that can be transmitted for a user in a given PRB and TTI, taking into account the estimated channel quality on that PRB as well as possibly reserved resources in that PRB. Hence, a PRB that is used for e.g. LTE physical broadcast channel (PBCH) would have zero estimated bits for all users. Similarly, a multimedia broadcast multicast service single frequency network (MBSFN) subframe would have zero estimated bits for all LTE wireless devices.
Synchronization signals and broadcast signals which must be sent in LTE and NR. Those signals are called PBCH/SS in LTE and synchronization signal block (SSB) in NR. The signals are used by wireless devices to find the cell and to access the network. In the spectrum sharing, the LTE PBCH/SS and NR SSB signals are allocated in different subframes and the subframes that send the NR SSBs are configured as MBSFN subframes. In this way, the NR SSB signal will not be interfered by the LTE signals such as LTE CRS. Some of these signals will be allocated to a set of PRBs (like LTE PBCH) while others (like NR SSBs) will require configuration of MBSFN subframes. To enable the model to predict how to split the spectrum in a given subframe it needs to know how many PRBs for each RAT will be removed due to overhead.
In the LTE PDCCH region, the PDCCH always spreads across the whole channel bandwidth, but the NR Control Resource Set (CORESET) region is localized to a specific region in the frequency domain. Thus, for NR, a parameter defining the frequency domain width for CORESET is necessary since the frequency domain width can be set in any value in the multiples of 6 RBs. This NR CORESET concept is defined in 3GPP TS 38.211 version 15.7.0 Release 15 and will therefore not be discussed in more detail herein. However, the network observation may comprise the CORESET configuration per PRB per NR wireless device. This would be needed to make sure that a wireless device that gets physical downlink shared channel (PDSCH) resources also gets some physical downlink control channel (PDCCH) resources within the bandwidth allocated to that RAT. A matrix with Nᵤₛₑᵣ×N_{prb}×Nₜₜᵢ elements, where each element indicates if the corresponding wireless device has a configured CORESET in that PRB and TTI. For LTE wireless devices, this matrix can be set to all zeros.
NR support, e.g., a vector with Nᵤₛₑᵣ elements that indicate if a wireless device is a NR user or not.
Buffer state, e.g., a vector with Nᵤₛₑᵣ elements containing the number of bits in the wireless device buffer.
Traffic type, e.g., a vector with Nᵤₛₑᵣ elements that indicate the type of traffic that the wireless device has.
Predicted packet arrivals, e.g., a matrix with Nᵤₛₑᵣ×Nₜₜᵢ elements that indicates the number of bits to arrive in the buffer for each user over some set of future subframes.

Time domain scheduling, e.g., by the functions 220, 230 in FIG. 2, is normally governed by a scheduling weight per wireless device where high weight means that it is important to schedule the wireless device. Typically, the way for how to calculate the weight is ultimately decided by the network operator and can for example be to base the weight for delay sensitive traffic on the time the oldest packet has been waiting in the buffer. Similarly, for best effort traffic the weight can be based on the proportional fair metric, where the weight is calculated from the ratio between the wireless devices instantaneous rate and its average rate. Since the network operator has already decided the overall goal for the prioritization between wireless devices, the same mechanism can be used to measure the quality of a scheduling decision.

As such, the reward function used in the current RL methods can be modeled as a summation of the exponential of the most delayed packet per user, e.g.,

$$Reward = {e}^{- {Σ}_{i = 1}^{N} w e {ight}_{i}}$$

where i={1, . . . , N} is the set of LTE/NR users in the network and weightᵢ is the weight of user i. If the scheduling function manages to keep user buffers empty the reward per slot will be one. If a highly prioritized wireless device is queued for several subframes its weight will increase, and the reward will approach zero. One advantage of this is that the range of the reward is fixed, which makes learning more efficient. Of course, other types of rewards can also be considered, or combinations of different reward metrics. One such example is to consider a hit-miss reward function where each wireless device that obtains its requested level of service is associated with a reward of, say 1, while a wireless device that does not obtain its requested level of service is associated with a reward of 0. A further example of reward function is a metric based on the time a packet spends waiting in a transmission buffer is measured, possibly in relation to the requirements on transmission delay imposed by the wireless device.

In real world scenarios it is challenging to deploy model-free methods because current state-of-the-art methods require millions of samples before any optimal policy is learned. Meanwhile, model-based RL methods focus on learning a predictive model of the real environment that is used to train a behavior of an agent. This can be more data efficient since the predictive model allows the agent to answer questions like “what would happen if I took action y instead of x in a given timestep?”. This is made possible with a predictive model that can be played out from a given state to evaluate different possibilities. Obviously, going back to a previous state is impossible in any real-life environment that would instead have to wait until the same (or similar) state is reached once more to try to answer the same question.

As such, it is proposed herein to adopt a model-based approach for training the RL methods where the arbitrator learns to predict those aspects of the future that are directly relevant for planning over a time window w. In particular, the proposed method may comprise a model that, when applied iteratively, predicts the quantities most directly relevant to planning, i.e., the reward, the action selection policy, and the value function for each state.

Some examples of the proposed method do not predict the actual network state but rather a hidden state representing the actual network state, and from that hidden state the method predicts the reward, policy, and value.

A representation function h is used to generate an initial hidden network state s⁰ given a network observation oₜ at a current time t. A dynamics function g is used to generate a new hidden network state s^{k} and an associated reward r^{k} given a hidden network state s^{k-1} and an action a^{k}. A prediction function f is configured to output a policy vector p^{k} and a value v^{k} given a network hidden state s^{k}.

The representation function h generates a representation of a current network state suitable for arbitration. The available data for network observation need not necessarily be a complete description of the network state, i.e., comprising all relevant variables. Rather, the representation function is able to learn to make use of the available information.

A policy vector is a vector of values which indicate a probability that a certain action gives high reward, i.e., a preferred action given the current network state and the future obtainable network states over the time window w. A close to uniformly distributed policy vector means that the algorithm has no real preference for a particular action, while a policy vector with a strong bias for some action means that this action is strongly preferred over the other actions given the current network state and the expected developments over the time window w. The value associated with a given state indicates the perceived value in terms of obtainable reward associated with visiting some state. An example value function may, e.g., be the maximum sum of rewards obtainable by visiting a given node, or an average measure of rewards obtainable by visiting a given node.

The representation function, the dynamics function, and the prediction function are preferably implemented as neural networks (NN), but other function implementations, such as look-up tables, are of course also possible.

A summary of the proposed technique for communications resource assignment in a wireless access network is summarized in FIG. 6 where the main steps are the following:
Step 1: The method obtains an observation oₜ of the network state as an input and transforms it into a hidden state s⁰ using the function approximation h, i.e., the representation function.
Step 2: The function approximation f, i.e., the prediction function, is used to predict the value function vⁱ and policy vector pⁱ for the current hidden state sⁱ.
Step 3: The hidden state is then updated iteratively to a next hidden state sⁱ⁺¹ by a recurrent process, using the dynamics function g, with an input representing the previous hidden state sⁱ and a hypothetical next action aⁱ⁺¹, i.e., a communications resource assignment selected from the action space comprising allowable communications resource assignments.

During training, the agent of the RL-based method interacts with the environment, i.e., the network, and it stores trajectories of the form (o, a, u, p), where o is an observation, a is the action taken, u is the reward and p is the policy target found during MCTS. The return is calculated for the sampled trajectory by accumulating discounted rewards, e.g., scheduler buffer states reduced by some discount factor, over the sequence. The policy target may, e.g., be calculated as the normalized number of times each action has been taken during MCTS after receiving an observation oₜ. For the initial step, the representation function h receives as input the observation oₜ from the selected trajectory. The model is subsequently unrolled recurrently for K steps, where K may be fixed or variable. At each step k, the dynamics function g receives as input the hidden state s^{k+1} from the previous step and the action a^{t+k}. Having defined a policy target, reward and value, the representation function h, dynamics function g, and prediction function f can be trained jointly, end-to-end by backpropagation-through-time (BPTT).

BPTT is a well-known gradient-based technique for training certain types of recurrent neural networks. It will therefore not be discussed in more detail herein.

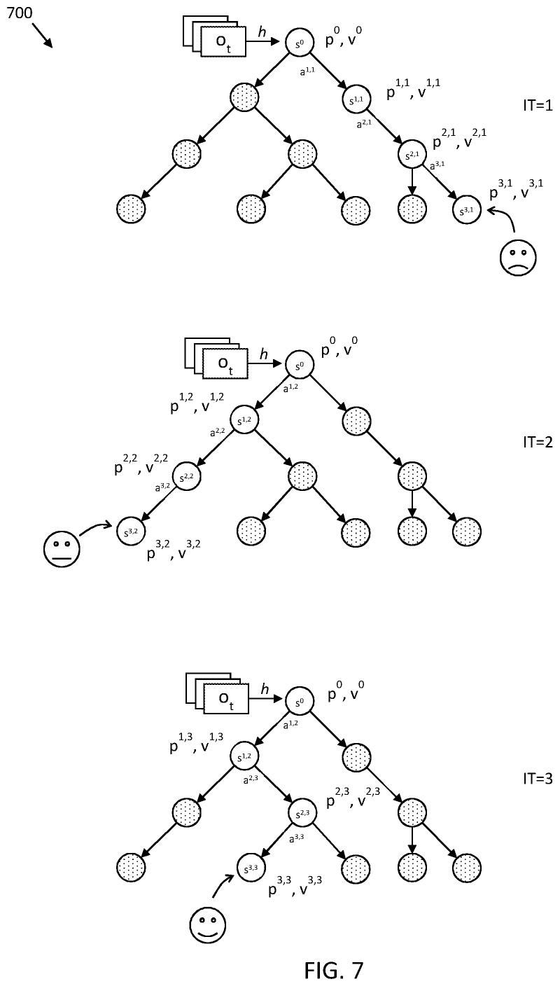

FIG. 7 illustrates some example iterations 700 of the proposed approach during run-time in a wireless access network, such as the wireless access network 100. It is assumed that function approximations h, f, and g are available. Each iteration starts with an observation of network current state oₜ. This observation is, generally and as noted above, not a complete description of network state comprising all the relevant variables. Rather, the observation only comprises a limited amount of information which indicates the current network state. The representation function h, which is preferably a neural network, has been trained to exploit the potentially limited data in the observation oₜ.

A hidden network state is denoted s^{i,k}, where i is the iteration index and k identifies a state at a given iteration. Similarly, an action, i.e., a communication resource split by the arbitrator function, is denoted a^{i,k}, where i is the iteration index and k distinguishes between different action at a given iteration. Actions and the related concept of an actions space will be discussed in more detail below. Vector p is a policy vector according to the discussions above, and v is a value.

At the first iteration, IT=1, the policy vector p⁰ at the initial state s⁰ indicates that action a^{1,1} is most suitable, so this action is taken, which results in state s^{1,1}. The prediction function f, when applied to state s^{1,1} yields a policy vector p^{1,1} and value v^{1,1} which prompts a resource assignment of a^{2,1}, followed by a resource assignment a^{3,1}. However, the sequence of network states s^{1,1}, s^{2,1} and s^{3,1} may not be ideal. For instance, the resource splits may have led to some important wireless devices failing to meet delay requirements, even though the first action a^{1,1} seemed the best one initially.

At the second iteration, IT=2, action a^{1,2} is selected instead of a^{1,1}. This instead leads to network state s^{1,2}. The sequence of states is then s^{2,2} followed by s^{3,2}. This sequence of network states may perhaps be slightly better than the result from the first iteration IT=1. Had the results been worse, the best option for resource assignment starting from the current network state would still have been a^{1,1}.

At the third iteration, IT=3, the same action a^{1,2} is initially selected, but this time the sequence of actions is a^{2,3} followed by a^{3,3}. This sequence of actions result in good results, where the requirements of the most prioritized wireless devices are met.

Thus, by predicting a sequence of future states of the wireless access network 100 by simulating hypothetical communication resource assignments a^{1,x}, a^{2,x}, a^{3,x} over a time window w starting from the current state, and evaluating a reward function for each hypothetical communication resource assignment over the time window, a resource assignment can be decided on which accounts for likely future consequences of the assignment. The simulation is based on a model of the network in which different communication resource assignments can be tested to see what the effects will be over time. The network model may be parametrized by, e.g., number of wireless devices, the amount of data to be transmitted, available communication resources, and so on.

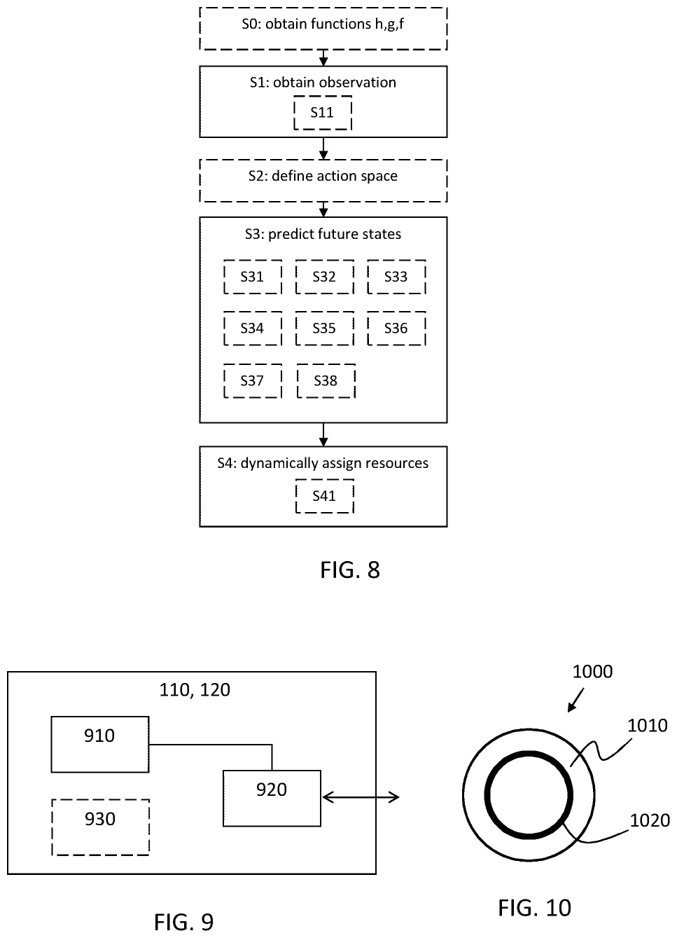

FIG. 8 is a flow chart illustrating a method for dynamically assigning communication resources 300, 400 between two or more RATs 145, 155 in a wireless access network 100 which summarizes the above discussions. The two or more RATs may, as discussed above comprise a 3GPP defined 4G, i.e., LTE, system and a 3GPP defined 5G, i.e., NR, system. However, the method is general and can be applied for dynamic spectrum sharing in a wide variety of wireless access networks.

The method comprises obtaining S1 a network observation oₜ indicating a current state of the wireless access network 100. The network observation oₜ may, for example comprise, for each user of the wireless access network 100, any of; predicted number of bits per physical resource block, PRB, and transmission time interval, TTI, pre-determined requirements on pilot signals, NR support, buffer state, traffic type, recurrently scheduled broadcasting communication resources, and predicted packet arrival characteristics. Generally, the network observation is a quantity of information which indicates a network state. The quantity of information is not necessarily complete, but only reflects parts of all the network parameters relevant for the resource assignment decision. Some parts of the network observation may be updated more often than other parts. The methods disclosed herein may be configured to account for such outdated information, e.g., by assigning different weights or associated time stamps to different parts of the network observation oₜ. For instance, suppose some variable in the network observation has not been updated for some time, then this part of the network observation can be considered outdated by the algorithm and not allowed to influence the resource assignment. It is an advantage of the proposed methods that the methods are able to adjust and provide relevant resource split decisions even if the network observation is not complete, and even if some parts of the network observation becomes outdated from time to time.

According to aspects, the method comprises defining S2 an action space comprising a pre-determined maximum number of allowable communication resource assignments. This bounded action space limits computational burden and simplifies implementations of the methods. For instance, a pre-determined number, say 8, of allowable resource splits may be defined by, e.g., an operator of the wireless access network 100. The method then selects from this bounded action set each time a resource assignment is to be made. FIGS. 4A-4F showed an example set of resource splits 400, 410, 420, 430, 440, 450. Generally, an operator may define a limited number of resource splits that the arbitrator function is allowed to use when dividing communications resources between the two or more RATs. This limited number of resource splits may, e.g., be configured such that at least one of the RATs is always provided a minimum number of communications resources, or a minimum number of control channel resources.

The method also comprises predicting S3 a sequence of future states of the wireless access network 100 by simulating hypothetical communication resource assignments a¹, a², a³ over a time window w starting from the current state, and evaluating a reward function for each hypothetical communication resource assignment a¹, a², a³ over the time window w. This prediction operation was exemplified and discussed above in connection to FIGS. 6 and 7. The length of the sequence of future states may be fixed, i.e., pre-determined, or variable. For instance, a tree such as that exemplified in FIG. 6 may be traversed down to a depth where sub-trees of the most uniformly distributed policy vectors have been at least partly searched. In other words, the method may comprise predicting S37 a variable length sequence of future states of the wireless access network or predicting S38 a pre-configurable fixed length sequence of future states of the wireless access network.

A simulation is an evaluation of the consequences of applying a given sequence of communication resource assignments in a wireless access network using a model of the wireless access network, such as a software model. The model can be set up or configured to reflect the actual wireless access network in terms of, e.g., number of connected users, transmission requirements from the users, and available communication resources. A sequence of communication resource assignments can be applied to the model, and the status of the network in terms of, e.g., transmission buffers (queued data packets) can be monitored to see if the resource assignment was a good one or not.

In general, the algorithm starts at an initial network state and evaluates different sequences of future resource assignments while observing the rewards associated with each sequence. According to aspects, the reward function corresponds to a weight metric used by respective communications resource scheduling functions 220, 230 of the two or more RATs 145, 155.

All possible actions over all iterations are generally not examined in this manner since this would imply an excessive computational burden, however, by investigating a few of the most promising, or even a single one, a good resource assignment can be decided on which accounts for likely future consequences of the resource assignment made starting from the initial network state.

The method comprises dynamically assigns S4 the communication resources 300, 400 based on the simulated hypothetical communication resource assignment a¹ associated with maximized reward function over the time window w when the wireless access network 100 is in the current state.

According to aspects, the prediction operation comprises performing S31 a Monte-Carlo Tree Search (MCTS) over the action space and over the time window w. With reference to FIG. 5 and FIG. 6, a tree search can be performed over future network states in the time window w to see the effects of a few candidate resource assignments. The decision of investigating more than one tree branch can be made, e.g., based on the policy vector p. The more uniformly distributed the policy vector p is at some node in the tree, the less certain a given action is to result in a desired overall network behaviour over the time window w. The value function associated with child nodes in the tree can also be used to investigate if more than one tree branch is to be searched.

According to aspects, the predicting is based on a model trained using a training method based on reinforcement learning (RL) S32. Reinforcement learning was discussed above and is also generally known.

With reference to FIG. 6, examples of the method comprise obtaining S0 a representation function h, a prediction function f, and a dynamics function g, wherein:

the representation function h is configured to encode the network observation oₜ into an initial hidden network state s⁰,
the prediction function f is configured to generate a policy vector p⁰, p¹, p², p³ and a value function v⁰, v¹, v², v³ for a hidden network state s⁰, s¹, s², s³, wherein the policy vector indicates a preferred communication resource assignment a¹, a², a³ given a hidden network state s⁰, s¹, s², s³ and the value function v⁰, v¹, v², v³ indicates a perceived value associated with the hidden network state, and
the dynamics function g is configured to generate a next hidden network state s^{t+1} in a sequence of hidden network states based on a previous hidden network state s^{t} and on a hypothetical communication resource assignment a¹, a², a³ at the previous hidden network state s^{t} comprised in an action space.

According to some such examples, the method further comprises

encoding S11 the network observation oₜ into an initial hidden network state s⁰ by the representation function h and,
predicting S33 the sequence of future states as a sequence of hidden network states s⁰, s¹, s², s³ starting from the initial hidden network state s⁰ by,
iteratively,
generating S34 a policy vector p⁰, p¹, p², p³ and a value function v⁰, v¹, v², v³ for a current hidden network state s⁰, s¹, s², s³ in the sequence of hidden network states by the prediction function f,
selecting S35 a hypothetical communication resource assignment a¹, a², a³ at the current hidden network state s⁰, s¹, s², s³ in the sequence based on any of the policy vector p⁰, p¹, p², p³, the value functions for child states of the current hidden network state and the number of times these child states have been visited during previous iterations, and
updating S36 the next hidden network state s^{t+1} in the sequence by the dynamics function g applied to the current hidden network state s^{t} in the sequence and on the selected hypothetical communication resource assignment a¹, a², a³, wherein the communication resources are dynamically assigned S41 based on the preferred communication resource assignment a¹ for the initial hidden network state s⁰ in the predicted sequence of future states.

FIG. 9 schematically illustrates, in terms of a number of functional units, the general components of network node 110, 120 according to embodiments of the discussions herein. The network node may, e.g., be an arbitration function in a radio base station or an element of the core network 120. Processing circuitry 910 is provided using any combination of one or more of a suitable central processing unit CPU, multiprocessor, microcontroller, digital signal processor DSP, etc., capable of executing software instructions stored in a computer program product, e.g. in the form of a storage medium 930. The processing circuitry 910 may further be provided as at least one application specific integrated circuit ASIC, or field programmable gate array FPGA.

Particularly, the processing circuitry 910 is configured to cause the device 110, 120 to perform a set of operations, or steps, such as the methods discussed in connection to FIG. 8 and the discussions above. For example, the storage medium 930 may store the set of operations, and the processing circuitry 910 may be configured to retrieve the set of operations from the storage medium 930 to cause the device to perform the set of operations. The set of operations may be provided as a set of executable instructions. Thus, the processing circuitry 910 is thereby arranged to execute methods as herein disclosed.

The storage medium 930 may also comprise persistent storage, which, for example, can be any single one or combination of magnetic memory, optical memory, solid state memory or even remotely mounted memory.

The device 110, 120 may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the device 110, 120, e.g., by sending data and control signals to the interface 920 and the storage medium 930, by receiving data and reports from the interface 920, and by retrieving data and instructions from the storage medium 930. Other components, as well as the related functionality, of the control node are omitted in order not to obscure the concepts presented herein.

FIG. 10 illustrates a computer readable medium 1010 carrying a computer program comprising program code means 1020 for performing the methods illustrated in, e.g., FIG. 8, when said program product is run on a computer. The computer readable medium and the code means may together form a computer program product 1000.

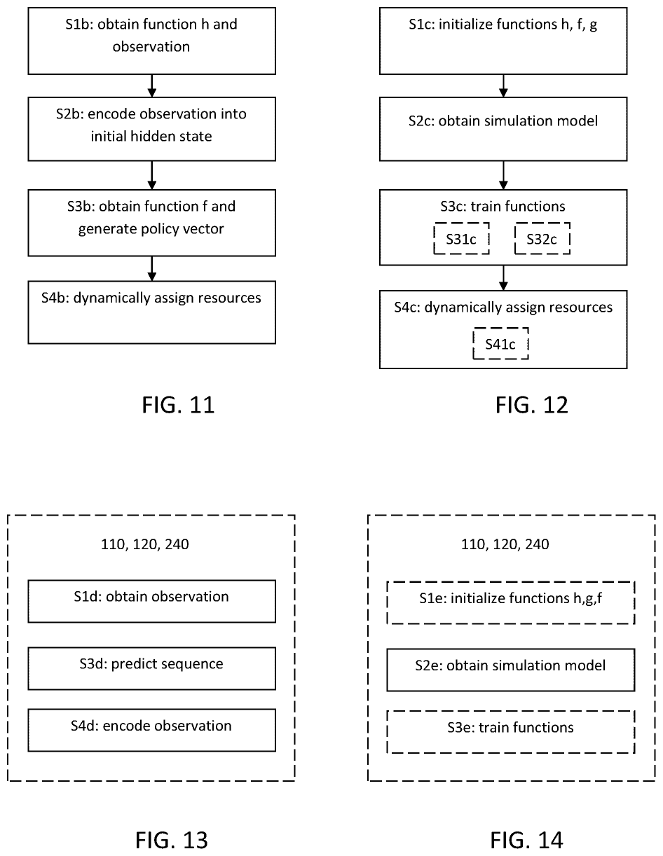

FIG. 11 is a flow chart illustrating a method for dynamically assigning communication resources 300, 400 between two or more RATs 145, 155, LTE, NR in a wireless access network 100. The method comprises:

obtaining S1b a representation function h and a network observation oₜ indicating a current state of the wireless access network 100,
encoding S2b the network observation oₜ into an initial hidden network state s⁰ by the representation function h,
obtaining S3b a prediction function f, wherein the prediction function f is configured to generate a policy vector p⁰, p¹, p², p³ for a hidden network state s⁰, s¹, s², s³, wherein a policy vector indicates a preferred communication resource assignment a¹, a², a³ given a hidden network state s⁰, s¹, s², s³, and
dynamically assigning S4b the communication resources 300, 400 based on the output of the prediction function f applied to the initial hidden network state s⁰.

FIG. 12 is a flow chart illustrating a method for dynamically assigning communication resources 300, 400 between two or more RATs 145, 155, LTE, NR in a wireless access network 100. The method comprises:

initializing S1c a representation function h, a prediction function f, and a dynamics function g, wherein:
the representation function h is configured to encode a network observation oₜ into an initial hidden network state s⁰,
the prediction function f is configured to generate a policy vector p⁰, p¹, p², p³ and a value function v⁰, v¹, v², v³ for a hidden network state s⁰, s¹, s², s³, wherein the policy vector indicates a preferred communication resource assignment a¹, a², a³ given a hidden network state s⁰, s¹, s², s³ and the value function v⁰, v¹, v², v³ indicates a perceived value associated with the hidden network state, and
the dynamics function g is configured to generate a next hidden network state s^{t+1} in a sequence of hidden network states based on a previous hidden network state s^{t} and on a hypothetical communication resource assignment a¹, a², a³ at the previous hidden network state s^{t} comprised in an action space,
obtaining S2c a simulation model of the wireless access network 100, wherein the simulation model is configured to determine consecutive network states resulting from of a sequence of communication resource assignments a¹, a², a³ starting from an initial network state,
training S3c the representation function h, the prediction function f, and the dynamics function g based on the determined consecutive network states starting from a plurality of randomized initial network states and on randomized sequences of communication resource assignments a¹, a², a³, and
dynamically assigning S4c the communication resources 300, 400 between the two or more radio access technologies, RAT, 145, 155, LTE, NR in the wireless access network 100 based on the representation function h, the prediction function f, and the dynamics function g.

According to aspects, the randomized sequences of communication resource assignments a¹, a², a³ are selected during training based on a Monte Carlo Tree Search (MCTS) operation.

According to aspects, the method further comprises training S41c the representation function h, the prediction function f, and/or the dynamics function g based on observations of the wireless access network 100 during the dynamic assignment of the communication resources 300, 400.

According to aspects, the method further comprises training S31c the representation function h, the prediction function f, and the dynamics function g based on randomized sequences of communication resource assignments a¹, a², a³, wherein the sequences of communication resource assignments a¹, a², a³ are of variable length.

According to aspects, the method further comprises training S32c the representation function h, the prediction function f, and the dynamics function g based on randomized sequences of communication resource assignments a¹, a², a³, wherein the sequences of communication resource assignments a¹, a², a³ are of a pre-configurable fixed length.

FIG. 13 schematically illustrates a network node 110, 120, 240, comprising:

processing circuitry 910;
a network interface 920 coupled to the processing circuitry 910; and
a memory 930 coupled to the processing circuitry 910, wherein the memory comprises machine readable computer program instructions that, when executed by the processing circuitry, causes the network node to:

obtain S1d a network observation oₜ indicating a current state of the wireless access network 100,

predict S3d a sequence of future states of the wireless access network 100 by iteratively simulating hypothetical communication resource assignments a¹, a², a³ over a time window w starting from the current state, and evaluating a reward function for each hypothetical communication resource assignment a¹, a², a³ over the time window w, and
dynamically assign S4d the communication resources 300, 400 based on the simulated hypothetical communication resource assignment a¹ associated with maximized reward function over the time window w when the wireless access network 100 is in the current state.

FIG. 14 schematically illustrates a network node 110, 120, 240, comprising:

processing circuitry 910;
a network interface 920 coupled to the processing circuitry 910; and a memory 930 coupled to the processing circuitry 910, wherein the memory comprises machine readable computer program instructions that, when executed by the processing circuitry, causes the network node to:
initialize S1e a representation function h, a prediction function f, and a dynamics function g, wherein:
the representation function h is configured to encode a network observation oₜ into an initial hidden network state s⁰,
the prediction function f is configured to generate a policy vector p⁰, p¹, p², p³ and a value function v⁰, v¹, v², v³ for a hidden network state s⁰, s¹, s², s³, wherein the policy vector indicates a preferred communication resource assignment a¹, a², a³ given a hidden network state s⁰, s¹, s², s³ and the value function v⁰, v¹, v², v³ indicates a perceived value associated with the hidden network state, and
the dynamics function g is configured to generate a next hidden network state s^{t+1} in a sequence of hidden network states based on a previous hidden network state s^{t} and on a hypothetical communication resource assignment a¹, a², a³ at the previous hidden network state s^{t} comprised in an action space,
obtain S2e a simulation model of the wireless access network 100, wherein the simulation model is configured to determine consecutive network states resulting from of a sequence of communication resource assignments a¹, a², a³ starting from an initial network state,
train S3e the representation function h, the prediction function f, and the dynamics function g based on the determined consecutive network states starting from a plurality of randomized initial network states and on randomized sequences of communication resource assignments a¹, a², a³, and
dynamically assign S4e the communication resources 300, 400 between the two or more radio access technologies, RAT, 145, 155, LTE, NR in the wireless access network 100 based on the representation function h, the prediction function f, and the dynamics function g.

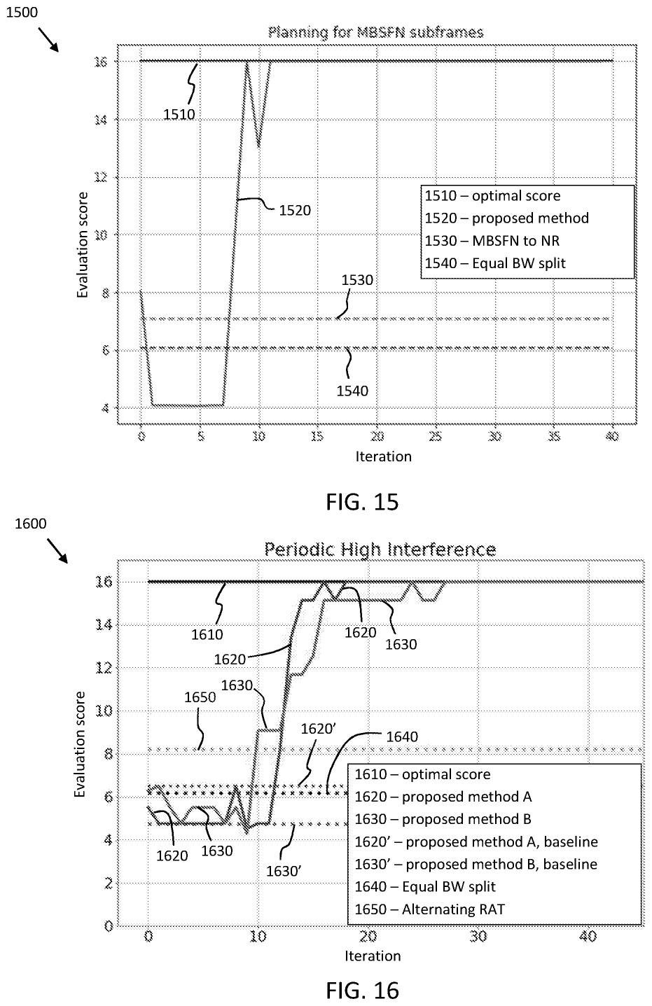

FIGS. 15 and 16 are graphs illustrating example results of applying the methods discussed above in a wireless access network such as the wireless access network 100. An evaluation score indicating scheduler states after the algorithm has run is shown versus iterations of the algorithm. The evaluation score is calculated as the sum of the rewards the agent receives during an episode, where the duration of the episode is 16 in these examples.

FIG. 15 shows an example 1500 where Multicast-broadcast single-frequency network (MBSFN) subframes are configured with a 4 ms period and the two last subframes in the pattern are MBSFN subframes. In MBSFN subframes there will be no LTE CRS transmission that otherwise have to be transmitted in all subframes. Hence this is a way to reduce the overhead, but since there are no LTE CRS only NR traffic can be scheduled in these subframes. Users have a small weight in the respective schedulers when delay is less than 3 ms but then increases abruptly. There are two wireless devices in the network (one NR user and one LTE user). A large data packet arrives for the NR user and a small one for the LTE user.

The assumed network observation is as discussed above and comprises information regarding upcoming MBSFN subframe onset times. A preferred strategy in this scenario is to start scheduling the LTE user such that the transmission buffer associated with the LTE user can be emptied before the MBSFN subframes (where no LTE users can be scheduled due to the lack of LTE CRS transmission).

The graph shows that the proposed algorithm relatively quickly “understands” that the LTE user should be scheduled early prior to the onset of the MBSFN subframes. The algorithm converges to the preferred communications resource assignment in about 11 iterations.

The optimal score 1510 is shown for comparison purposes. The results of the proposed method is indicated by the curve 1520 which starts at a score of about 8 which first decreases but then relatively quickly increases up to the optimal value as the algorithm understand the best assignment strategy for this scenario.

For comparison purposes, the corresponding evaluation scores for a method 1530 which always assigns all MBSFN subframes to NR is shown and also the evaluation score for a method 1540 which always applies a fixed and equal bandwidth split between LTE and NR.

FIG. 16 shows an example 1600 where the proposed methods are used to account for future high interference on one of the wireless devices in the network. This could for instance correspond to a scenario where a wireless device is located at the cell edge in the wireless access network 100.

There are two wireless devices (one NR user and one LTE user). A larger packet size for NR user compared to that of LTE is assumed. In this case the NR user is expected to benefit from the 2 extra symbols of LTE PDCCH if it is given all the BW. Periodic traffic arrival rate with a periodicity of 2 ms is assumed. Periodic high interference on the LTE user is applied every 3 subframes. Users have a small scheduler weight when delay is smaller than 2 ms but then increases abruptly.

The assumed network observation is as discussed above and here notably comprises information regarding predicted number of bits per PRB and subframe.

The preferred strategy in this case is to allocate the full BW to NR during subframes of high interference value on LTE.

The proposed methods are shown to reach the desired behaviour after about 20 iterations.

The optimal evaluation score in this case is again illustrated by the top curve 1610. The proposed method where the action space has been adjusted from an action set with relatively few actions to choose from (proposed method A) is shown as curve 1620 while the proposed method having access to a finer granularity of actions (proposed method B) is shown as curve 1630. It is noted that the finer granularity here slows down convergence somewhat, although not significantly, and both versions of the proposed method reaches the optimal evaluation score. The corresponding results 1620′, 1630′ where no prediction on future bits per PRB is comprised in the observation is also shown, as well as the results for a fixed and equal bandwidth split 1640 and an alternating RAT method 1650. Notably, and as expected, these methods do not improve over iterations.

1. A computer implemented method for dynamically assigning communication resources between two or more radio access technologies, RAT, in a wireless access network, the method comprising:
obtaining a network observation indicating a current state of the wireless access network;
predicting a sequence of future states of the wireless access network by simulating hypothetical communication resource assignments over a time window starting from the current state, and evaluating a reward function for each hypothetical communication resource assignment over the time window; and
dynamically assigning the communication resources based on the simulated hypothetical communication resource assignment associated with maximized reward function over the time window when the wireless access network is in the current state.

2. The method according to claim 1, wherein the two or more RATs comprise a third-generation partnership program, 3GPP, defined fourth generation, 4G, (LTE) system and a 3GPP defined fifth generation, 5G, (NR) system.

3. The method according to claim 1, wherein the network observation comprises, for each user of the wireless access network, any of:
predicted number of bits per physical resource block, PRB, and transmission time interval, TTI, pre-determined requirements on pilot signals, NR support, buffer state, traffic type, recurrently scheduled broadcasting communication resources, and predicted packet arrival characteristics.

4. The method according to claim 1, comprising defining an action space comprising a pre-determined maximum number of allowable communication resource assignments.

5.-6. (canceled)

7. The method according to claim 1, wherein the reward function corresponds to a weight metric used by respective communications resource scheduling functions of the two or more RATs.

8. The method according to any previous claim 1, comprising:
obtaining a representation function, a prediction function, and a dynamics function, wherein:
the representation function is configured to encode the network observation into an initial hidden network state;
the prediction function is configured to generate a policy vector and a value function for a hidden network state, wherein the policy vector indicates a preferred communication resource assignment given a hidden network state and the value function indicates a perceived value associated with the hidden network state; and
the dynamics function is configured to generate a next hidden network state in a sequence of hidden network states based on a previous hidden network state and on a hypothetical communication resource assignment at the previous hidden network state comprised in an action space;
the method further comprising:
encoding the network observation into an initial hidden network state by the representation function; and
predicting the sequence of future states as a sequence of hidden network states starting from the initial hidden network state by, iteratively:
generating a policy vector and a value function for a current hidden network state in the sequence of hidden network states by the prediction function;
selecting a hypothetical communication resource assignment at the current hidden network state in the sequence based on any of the policy vector, the value functions for child states of the current hidden network state and the number of times these child states have been visited during previous iterations; and
updating the next hidden network state in the sequence by the dynamics function applied to the current hidden network state in the sequence and on the selected hypothetical communication resource assignment,
wherein the communication resources are dynamically assigned based on the preferred communication resource assignment for the initial hidden network state in the predicted sequence of future states.

9. The method according to claim 1, comprising:
predicting a variable length sequence of future states of the wireless access network.

10. The method according to claim 1, comprising:
predicting a pre-configurable fixed length sequence of future states of the wireless access network.

11. (canceled)

12. A computer implemented method, performed by a network node, for dynamically assigning communication resources between two or more radio access technologies, RAT, in a wireless access network, the method comprising:
obtaining a representation function and a network observation indicating a current state of the wireless access network;
encoding the network observation into an initial hidden network state by the representation function;
obtaining a prediction function, the prediction function being configured to generate a policy vector for a hidden network state, a policy vector indicating a preferred communication resource assignment given a hidden network state; and
dynamically assigning the communication resources based on the output of the prediction function applied to the initial hidden network state.

13. A computer implemented method, performed by a network node, for dynamically assigning communication resources between two or more radio access technologies, RAT, in a wireless access network, the method comprising:
initializing a representation function, a prediction function, and a dynamics function:
the representation function being configured to encode a network observation into an initial hidden network state;
the prediction function being configured to generate a policy vector and a value function for a hidden network state, the policy vector indicating a preferred communication resource assignment given a hidden network state and the value function indicates a perceived value associated with the hidden network state; and
the dynamics function being configured to generate a next hidden network state in a sequence of hidden network states based on a previous hidden network state and on a hypothetical communication resource assignment comprised in an action space,
obtaining a simulation model of the wireless access network, wherein the simulation model is configured to determine consecutive network states resulting from of a sequence of communication resource assignments starting from an initial network state,
training the representation function, the prediction function, and the dynamics function based on the determined consecutive network states starting from a plurality of randomized initial network states and on randomized sequences of communication resource assignments, and
dynamically assigning the communication resources between the two or more radio access technologies, RAT, in the wireless access network based on the representation function, the prediction function, and the dynamics function.

14. The method according to claim 13, wherein the randomized sequences of communication resource assignments are selected during training based on a Monte Carlo Tree Search, MCTS, operation.

15. The method according to claim 13, further comprising training one or more of the representation function, the prediction function and the dynamics function based on observations of the wireless access network during the dynamic assignment of the communication resources.

16. The method according to claim 13, comprising training the representation function, the prediction function, and the dynamics function based on randomized sequences of communication resource assignments, wherein the sequences of communication resource assignments are of variable length.

17. The method according to claim 13, comprising training the representation function, the prediction function, and the dynamics function based on randomized sequences of communication resource assignments, wherein the sequences of communication resource assignments are of a pre-configurable fixed length.

18. (canceled)

19. (canceled)

20. A network node, comprising:
processing circuitry;
a network interface coupled to the processing circuitry; and
a memory coupled to the processing circuitry, the memory comprising machine readable computer program instructions that, when executed by the processing circuitry, causes the network node to:
obtain a network observation indicating a current state of the wireless access network;
predict a sequence of future states of the wireless access network by iteratively simulating hypothetical communication resource assignments over a time window starting from the current state, and evaluating a reward function for each hypothetical communication resource assignment over the time window; and
dynamically assign the communication resources based on the simulated hypothetical communication resource assignment associated with maximized reward function over the time window when the wireless access network is in the current state.

21. The network node according to claim 20, wherein the network node comprises an arbitration function configured to arbitrate between an LTE scheduling function and an NR scheduling function in a wireless access network.

22. A network node, comprising:
processing circuitry;
a network interface coupled to the processing circuitry; and
a memory coupled to the processing circuitry, wherein the memory comprises machine readable computer program instructions that, when executed by the processing circuitry, causes the network node to:
initialize a representation function, a prediction function, and a dynamics function:
the representation function being configured to encode a network observation into an initial hidden network state;
the prediction function being configured to generate a policy vector and a value function for a hidden network state, the policy vector indicating a preferred communication resource assignment given a hidden network state and the value function indicates a perceived value associated with the hidden network state, and
the dynamics function being configured to generate a next hidden network state in a sequence of hidden network states based on a previous hidden network state and on a hypothetical communication resource assignment at the previous hidden network state comprised in an action space;
obtain a simulation model of the wireless access network, the simulation model being configured to determine consecutive network states resulting from of a sequence of communication resource assignments starting from an initial network state;
train the representation function, the prediction function, and the dynamics function based on the determined consecutive network states starting from a plurality of randomized initial network states and on randomized sequences of communication resource assignments; and
dynamically assign the communication resources between the two or more radio access technologies, RAT, in the wireless access network based on the representation function, the prediction function, and the dynamics function.

23. The network node according to claim 22, wherein the network node comprises an arbitration function configured to arbitrate between an LTE scheduling function and an NR scheduling function in a wireless access network.
